(19) United States
(12) Patent Application Publication
(10) Pub. No.: US 2002/0080028 A1
(43) Pub. Date: Jun. 27, 2002

(54) Emergency Alert system and thumb actuated button emergency alert communicator

(76) Inventor: Marlena Edwards, Washington, DC (US)

Correspondence Address: CAHN & SAMUELS LLP, 2000 P STREET NW, SUITE 200, WASHINGTON, DC, 20036, US

(21) Appl. No.: 10/003,469

(22) Filed: Dec. 6, 2001

Related U.S. Application Data
(60) Provisional application No. 60/251,330, filed on Dec. 6, 2000.

(51) Int. Cl. G08B 21/00

(52) U.S. Cl. 340/540; 340/573.1

(57) ABSTRACT

A thumb-actuated button emergency alert communicator includes a housing having a top surface, a bottom surface, a front surface, a rear surface and first and second side surfaces. A position calculation unit is disposed within said housing. A switch is disposed on the top surface of said housing proximate to a first side surface, the switch preferably including a thumb actuated button. The thumb-actuated button is further positioned such that, when communicator is grasped in the palm of the hand, the thumb actuated button is disposed below the user's thumb and adjacent to the fingers such that the thumb actuated button may be triggered by a simple, natural downward motion of the thumb. When the thumb actuated button is triggered, the position calculation unit generates a position signal including data identifying the present position of the hand held personal emergency alert device. The communicator further establishes a communication path between itself, the application server and an emergency alert operator.

This application claims the benefit of U.S. Provisional Patent Application No. 60/251,330 filed Dec. 6, 2000.

### I. FIELD OF THE INVENTION

This invention relates to an emergency alert system that employs an easy access thumb-actuated emergency alert communicator.

### II. BACKGROUND OF THE INVENTION

There is a desire to link mobile communications devices with the 911 emergency alert system. In the case of mobile telephones, the Federal Communications Commission (FCC)) has promulgated regulations that require emergency service personnel to receive the phone number of any cell phone placing an emergency service call and to retrieve the location of the cell site that handled the call. In order to carry out this FCC mandate, the emergency personnel need to employ a tracking system that will be able to pinpoint the location of the phone. However, few if any emergency operators have such a system in place today.

Chapman Technologies, Inc. of Fort Lauderdale, Fla. has developed a system and device that facilitates reporting the position and conditions of a mobile communication device user to an emergency operator. More particularly, the Chapman system comprises a single button actuated, hand-held electronic device having cellular communication capabilities. The hand-held device has an actuation button disposed on the front face thereof. The hand held device is designed to be carried in a purse or car or to be clipped to a user's or placed in a user's pocket.

The handheld device employs a GPS receiver that transmits position coordinates to a command center computer and places a cellular call to the command center when the user depresses the button. The command center computer generates a map to allow a command center operator to read the users exact location. The command center operator then contacts the emergency operator on behalf of the user. U.S. Pat. Nos. 5,996,093 and 5,504,491 assigned to Chapman Technologies are both directed to the Chapman device and system.

Although the Chapman device represents an advance in emergency alert systems, the prior art hand-held emergency alert systems are not readily accessible by the user because 1) the trigger mechanism is located in a cumbersome position and 2) the devices typically are stored in locations that are difficult to reach under duress.

In addition, known emergency alert systems require that a voice link be established between a user and a command center operator and that the command center operator contact the emergency operators. The problem with this approach is twofold. First, in emergency situations, time is of the essence. No matter how fast or efficient the command center operator may be, it slows down dissimenation of information to the emergency operator. Second, it requires a human operator which incresases the expense of the system and increases the margin for error in getting the emergency message to the emergency operator.

### III. SUMMARY OF THE INVENTION

This invention provides a thumb-actuated button emergency alert communicator having a housing including a top surface, a bottom surface, a front surface, a rear surface and first and second side surfaces. A position calculation unit is disposed within said housing. A switch is disposed on the top surface of said housing proximate to a first side surface, the switch preferably including a thumb-actuated button. The thumb-actuated button is further positioned such that, when the communicator is grasped in the palm of the hand, the thumb-actuated button is disposed below the user's thumb and adjacent to the fingers such that the thumb actuated button may be triggered by a simple, natural downward motion of the thumb. When the thumb-actuated button is triggered, the position calculation unit generates a position signal including data identifying the present position of the communicator. The communicator further establishes a communication path between itself, the application server and an emergency alert operator.

According to one aspect of the invention, the invention is a personal emergency alert system that includes a thumb-actuated emergency alert communicator including a position calculation unit, a switch disposed on said communicator that, when actuated, causes the position calculation unit to generate a position signal including data identifying the present position of said communicator, a communication link that transmits the position signal upon actuation of the switch and that establishes a data communication path with an emergency alert operator permitting communication to and from the emergency operator; and an application server that receives the position signal, said application server including a converter that converts position data to spoken instructions and broadcasts the spoken instructions to the emergency operator responsive to a command transmitted by one of the communicator and the emergency operator.

According to another aspect of the invention, the invention is a thumb-actuated emergency alert communicator that includes a housing having a top surface, a bottom surface, a rear surface, a front surface and first and second side surfaces; a position calculation unit disposed within said housing; a switch disposed on the top surface of said housing proximate to an edge of the top surface in such a manner that a user, when grasping the communicator, can rapidly trigger the switch with a simple downward flex of the thumb, said switch, when actuated, causing the position calculation unit to generate a position signal including data identifying the present position of the hand held personal emergency alert device; and a communication link that establishes a communication path between said hand held device, an application server and an emergency alert operator, said communication link transmitting the position signal to said application.

According to another aspect of the invention, the invention is a hand held personal emergency alert device in combination with a carrying assembly that includes a flexible band operable to be placed over the palm of a user's hand and a pocket disposed on the band and a handheld personal emergency alert device disposed within the pocket of the carrying assembly such that the switch is disposed below the user's thumb.

According to another aspect of the invention, the invention is a carrying assembly for a hand held personal emergency alert device that includes a flexible band operable to be placed over the palm of a user's hand and a pocket disposed on the band for housing the hand held emergency alert device and positioning the device within the palm of the user's hand.

According to another aspect of the invention, the invention is a method of operation for a thumb-actuated emergency alert communicator that includes generating a position signal including data indicative of the position of the communicator; establishing a multi party communication path between the communicator, an application server and an emergency alert operator; transmitting the position signal to the application server; and providing a representation of the position signal to the emergency alert operator.

According to another aspect of the invention, the invention may be implemented as in an emergency alert system having a thumb-actuated emergency alert communicator and an application server, a method of operation of the application server includes receiving a position signal including data indicative of the location of the hand held personal emergency alert device; converting the position signal to verbal indicia; and transmitting the verbal indicia to an emergency alert operator responsive to an audio command.

It is an object of the invention to provide an improved thumb actuated emergency alert communicator that may be easily and quickly triggered.

It is another object of the invention to provide systems and method to improve access to reduce time and effort required to trigger handheld emergency alert devices.

It is still a further object of the invention to provide a fully automated system to transmit cellular call and position data to an emergency operator

Given the following enabling description of the drawings, the apparatus should become evident to a person of ordinary skill in the art.

### IV. BRIEF DESCRIPTION OF THE DRAWINGS

FIG. 1 illustrates a personal emergency alert system in accordance with the invention.

FIG. 2 illustrates a cut away side view of a carrying unit in accordance with the invention.

FIG. 3 shows the communicator disposed in a carrying unit held by a user.

### V. DETAILED DESCRIPTION OF THE DRAWINGS

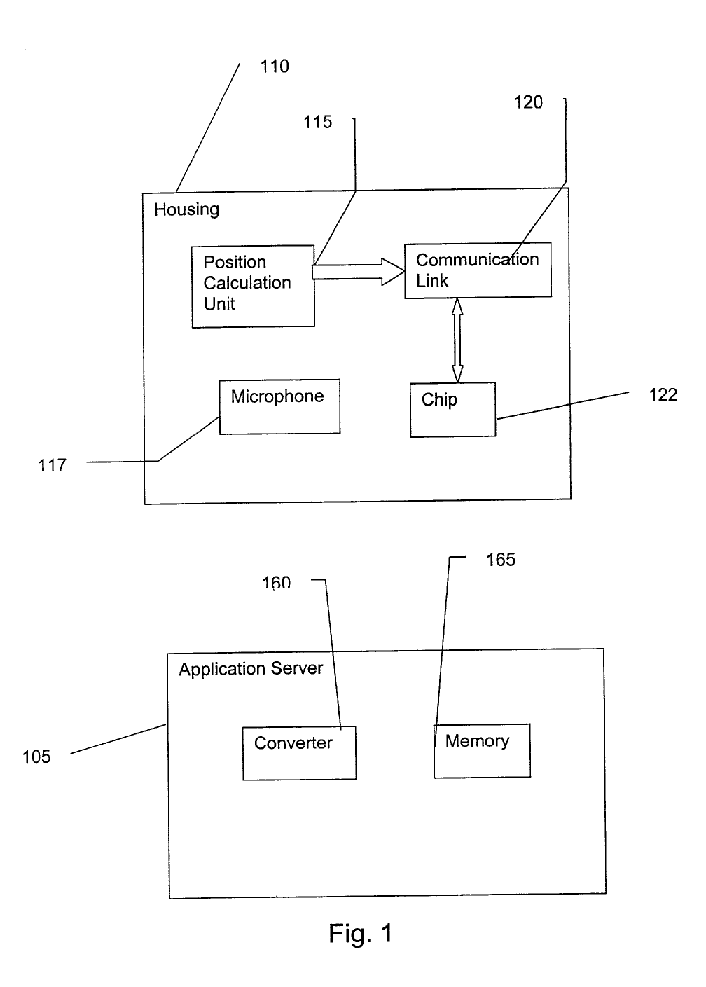

In accordance with an embodiment of the invention, as illustrated in FIG. 1, a personal emergency alert system comprises a thumb actuated button emergency alert communicator 100 and an application server 105 that communicates with the thumb actuated emergency alert communicator 100. The thumb-actuated emergency alert communicator 100 preferably includes a housing 110 encompassing a position calculation unit 115, a microphone 117 and a communication link 120. The housing includes a top surface 125, a bottom surface 130, a front surface 135, a rear surface 140 and first and second side surfaces 145 and 150. A thumb-actuated button 155 is disposed on the top surface and positioned proximate to an edge of the top surface 125 in such a manner that the user, when grasping communicator 120 in its hand, can rapidly trigger button 155 with a simple downward flex of its thumb. When the thumb-actuated button 155 is triggered, communication link 120 preferably establishes a communication path between communicator 100, application server 105 and an emergency operator (not shown). This communication path allows the user to speak with the emergency operator and inform the operator of the user's location and the nature of the user's emergency.

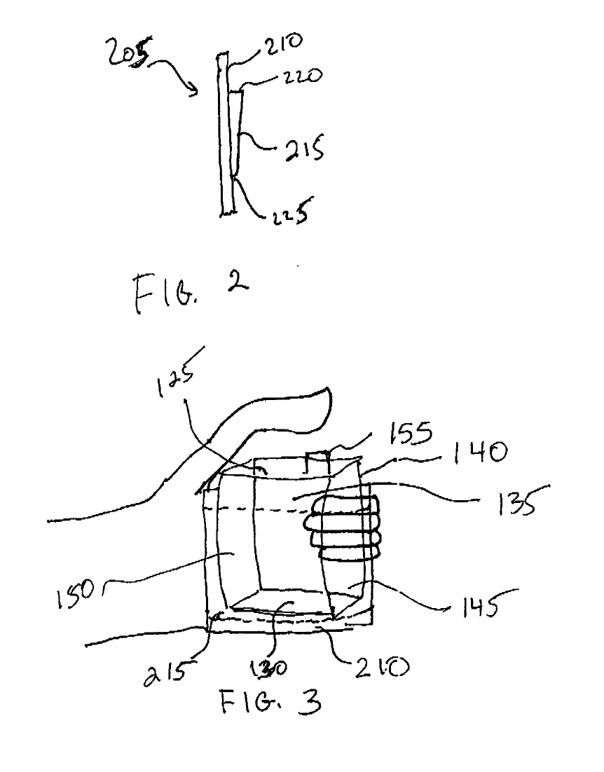

To facilitate rapid triggering of communicator 100, as shown in FIG. 2, communicator 100 may be placed in a carrying unit 205 that is operable to be attached to the user's hand. Carrying unit 205 includes a flexible band 210 operable to be placed over the palm of a user's hand and a pocket 215 disposed on band 210 for housing communicator 100. Carrying unit 205 secures communicator 100 to the user's hand and positions communicator 100 within the palm of the user's hand such that the thumb actuated button 155 is within easy reach of the user's thumb. By securing communicator 100 to the user's hand, it greatly decreases the time and difficulty of triggering communicator 100, especially in an emergency situation.

Returning to FIG. 1, the system is further provided with application server 105. Application server 105 is preferably a PC that includes a converter 160 that converts position data to spoken instructions and broadcasts the spoken instructions to the emergency operator responsive to a command. Preferably, converter 160 is triggered by a voice command from either the user or from the emergency operator. Accordingly, converter 160 will not interrupt the user while he is communicating his emergency to the emergency operator. In accordance with an aspect of the invention, application server 105 may also save any communications transmitted by the user, the emergency operator and/or the converter for later use by investigative authorities, for example.

The Thumb Actuated Emergency Alert Communicator

Turning to thumb-actuated communicator 100 in more detail, as illustrated by the arrows in FIG. 1, position calculating unit 115 transmits position signals to communication link 120 responsive to the user triggering thumb-actuated button 155. In a preferred embodiment of the invention, position calculation unit 115 may be a standard GPS receiver. Exemplary GPS receivers that may be employed in communicator 100 include receivers marketed under the trademarks SiRFLoc™ and SnapStart™, respectively, both available from SIRF Technologies, Inc. of San Jose, Calif.

Communication link 120 is preferably a cellular phone architecture of the type known to those of skill in the art. However, in other embodiments, communication link 120 may be pager or other type wireless communication system capable of receiving and transmitting voice and data information. Thus, upon triggering of the thumb-activated button, communication link 120 preferably establishes a telephonic connection between communicator 100, application server 105 and the emergency operator which allows the user and the emergency operator to verbally exchange emergency information.

To make conversation with the emergency operator easier for the user, communicator 100 may incorporate a Bluetooth chip 122, other application specific integrated circuit (ASIC), or other circuitry. This will allow the user to employ, e.g., a Bluetooth enabled headset as a microphone and receiver thereby eliminating the need for the user to position communicator 100 for talking and reposition communicator 100 for listening. A suitable Bluetooth enabled headset is the BlueMoon Single Voice headset available from Infineon Technologies, AG of Munich, Germany.

In accordance with the invention, communicator 100 may be provided with other features commonly found on handheld electronic devices such as a personal digital assistant (PDA) or an e-book. For example, communicator 100 may include a digital calendar, a digital clock, a game module, etc.

To facilitate rapid triggering of the system, communicator 100 is provided with a switch preferably in the form of thumb-actuated button 155. Thumb actuated button 155 is preferably positioned on the top surface 125 of housing 110 proximate to first side surface 145 which, when communicator 100 is held by the user, is adjacent the user's fingers as illustrated in FIG. 3. Accordingly, once the user grasps communicator 100 and properly positions communicator 100 in his/her hand, communicator 100 may be triggered very easily by the natural downward motion of the thumb. Alternatively, thumb-actuated button may be disposed on another surface of housing 110, e.g., front surface 135. However, it is more difficult for the user to trigger communicator 100 when the thumb actuated button 155 is placed on front face 135 as it requires the user to swing his thumb in an arcuate motion over top surface 125, and downward and in towards front surface 135. This motion is more awkward and less efficient than the natural downward motion of the thumb and it is likely to cause the user to miss any button disposed on front face 135.

During an emergency situation, the time required to access communicator 100 may be critical, especially if the user is being attacked or has suffered a sudden severe ailment. To address the need for ready access to communicator 100, as shown in FIG. 2, the present invention includes a carrying unit 205 for securing communicator 100 in the user's hand in a position where the thumb-actuated button 155 is within easy reach as described above. In accordance with an aspect of the invention, carrying unit 205 comprises a flexible band 210 that may be formed from either a stretch or non-stretch material. Preferably, flexible band 210 is formed from an elastic material. It is preferred that flexible band 210 fit snuggly around the user's hand to reduce the likelihood of slippage when the user is engaging in vigorous exercise or other activities that require a great deal of movement. Alternatively, the flexible band 210 may be a part of or replaced by a glove.

In keeping with the invention, flexible band 210 is provided with a securing device to hold communicator 100 in place. In a preferred embodiment, the securing device is pocket 215. However, the skilled artisan will readily recognize that numerous other securing devices may be employed with flexible band 205 depending upon the construction of communicator 100. One alternative embodiment for the securing device is a slot for insertion of a clip present on a back surface of communicator 100.

Pocket 215 includes an open end 220 dimensioned to receive communicator 100 and a closed end 225 to hold communicator 100 therein. If desired, to further secure communicator 100, straps may be provided across open end 220 and secured to pocket 215 with, e.g., VELCRO®. Pocket 215 may be integrally formed with flexible band 210 or it may be separately attached to flexible band 210. Although pocket 215 may generally be formed from the same material as used for flexible band 210, if there are keys on front surface 135 of communicator 100, it is preferred that pocket 215 be constructed from a transparent/translucent material so that the user can see and operate the keys.

By securing communicator 100 in carrying unit 205 and securing carrying unit 205 to the user's hand as illustrated in FIG. 3, the user always has access to communicator 100 and can trigger communicator 100 almost instantly through his natural thumb motion. This is a substantial advantage over prior art systems that provide no mechanism for the user to have the communicator in his hand at the critical time. In fact, the prior art teaches that hand-held emergency alert devices should be stowed on the user's belt or in the user's handbag.

Application Server

In keeping with the invention, application server 105 is provided to facilitate transmission of position data and other information from communicator 100 to the emergency operator. As mentioned above, application server 105 is preferably a programmed computer such as a personal computer. Application server 105 preferably includes converter 160 for converting GPS position signals into spoken position or location coordinates and a memory 165 for storing information such as the GPS position signal, the emergency call, and the like. This converter is preferably voice activated so that anyone with a voice link to application server 105 could request that GPS position coordinates. In accordance with the invention, both the user and the emergency operator have a voice link with application server 105. Communicator 100 transmits GPS position signals to application server 105. Hence, both the user and the emergency operator can prompt application server 105 to announce GPS position coordinates of communicator 100 by employing the appropriate voice command. An exemplary converter 160 is marketed under the name TeleNavigation.voice available from Televigation, Inc. of Sunnyvale, Calif. Alternatively, the converter 160 may be incorporated into the communicator 100 such that a communication pathway is created between the communicator 100 and the emergency operator.

In accordance with an aspect of the invention, application server 105 saves the content of the communications each time communicator 100 establishes a communication pathway with application server 105 and the emergency operator. Application server 105 preferably saves this information in memory 165.

System Operation

In keeping with the invention, when the user triggers thumb-actuated button 155, communicator 100 transmits GPS position signals to application server 105 and to the emergency operator. In a preferred embodiment, the user must depress the thumb-actuated button twice in order to trigger the communicator. This dual trigger mode is present to prevent accidental or inadvertent calls to the emergency operator. However, it should be noted that it is well within the scope of the invention to set the communicator to single trigger mode or multiple trigger modes if desired.

When communicator 100 is triggered, a communication pathway is established with both application server 105 and the emergency operator. In preferred embodiments, the communication pathway is a cellular call. If the user is unable to tell the emergency operator his whereabouts, either the user or the emergency operator may request that the application server state the user's whereabouts using a simple command.

Those skilled in the art will appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

I claim:

1. A personal emergency alert system comprising:
a thumb actuated emergency alert communicator including a position calculation unit, a switch disposed on said communicator that, when actuated, causes the position calculation unit to generate a position signal including data identifying the present position of said communicator, a communication link that transmits the position signal upon actuation of the switch and that establishes a data communication path with an emergency alert operator permitting communication to and from the emergency operator; and
an application server that receives the position signal, said application server including a converter that converts position data to spoken instructions and broadcasts the spoken instructions to the emergency operator responsive to a command transmitted by one of the communicator and the emergency operator.

2. A thumb-actuated emergency alert communicator comprising:
a housing including a top surface, a bottom surface, a rear surface, a front surface and first and second side surfaces;
a position calculation unit disposed within said housing;
a switch disposed on the top surface of said housing proximate to an edge of the top surface in such a manner that a user, when grasping the communicator, can rapidly trigger the switch with a simple downward flex of the thumb, said switch, when actuated, causing the position calculation unit to generate a position signal including data identifying the present position of the hand held personal emergency alert device; and
a communication link that establishes a communication path between said hand held device, an application server and an emergency alert operator, said communication link transmitting the position signal to said application.

3. A hand held personal emergency alert device in combination with a carrying assembly comprising:
a flexible band operable to be placed over the palm of a user's hand and a pocket disposed on the band;
the hand held personal emergency alert device of claim 2 disposed within the pocket of the carrying assembly such that the switch is disposed below the user's thumb.

4. A carrying assembly for a hand held personal emergency alert device comprising:
a flexible band operable to be placed over the palm of a user's hand and a pocket disposed on the band for housing the hand held emergency alert device and positioning the device within the palm of the user's hand.

5. A method of operation for a thumb actuated emergency alert communicator comprising:
generating a position signal including data indicative of the position of the communicator;
establishing a multi party communication path between the communicator, an application server and an emergency alert operator;
transmitting the position signal to the application server; and
providing a representation of the position signal to the emergency alert operator.

6. In an emergency alert system comprising a thumb actuated emergency alert communicator and an application server, a method of operation of the application server comprising:
receiving a position signal including data indicative of the location of the hand held personal emergency alert device;
converting the position signal to verbal indicia; and
transmitting the verbal indicia to an emergency alert operator responsive to an audio command.
